(19) United States
(12) Patent Application Publication
(10) Pub. No.: US 2022/0064909 A1
(43) Pub. Date: Mar. 3, 2022

(54) PERIPHERY MONITORING APPARATUS FOR WORK MACHINE

(71) Applicant: KOBELCO CONSTRUCTION MACHINERY CO., LTD., HIROSHIMA-SHI, HIROSHIMA (JP)

(72) Inventors: Hitoshi SASAKI, HIROSHIMA-SHI, HIROSHIMA (JP); Yoichiro YAMAZAKI, HIROSHIMA-SHI, HIROSHIMA (JP); Seiji SAIKI, HIROSHIMA-SHI, HIROSHIMA (JP)

(21) Appl. No.: 17/435,570

(22) PCT Filed: Dec. 2, 2019
(86) PCT No.: PCT/JP2019/047026

§ 371 Date: Sep. 1, 2021

(30) Foreign Application Priority Data
Mar. 13, 2019 (JP) 2019-045388

(51) Int. Cl. E02F 9/26; E02F 9/24; G08B 3/10

(52) U.S. Cl. CPC E02F 9/26; E02F 9/205; G08B 3/10; E02F 9/24

(57) ABSTRACT

A periphery monitoring apparatus for a work machine determines at least one part of a plurality of target spaces as a “first designated target space”, according to an action mode of the work machine, which is predicted on the basis of an operation state by the operator of an operating device of the work machine. When a position of the object is included in the first designated target space, an alarm is output by the first designated output device that is arranged in an azimuth corresponding to an azimuth of the first designated target space with reference to the work machine, with reference to a location of the operator in a driving space of the work machine. The alarm is differentiated according to a varying mode of a relative position between the work machine and the object.

### TECHNICAL FIELD

The present invention relates to an apparatus for monitoring the periphery of a work machine.

### BACKGROUND ART

In order to enable an operator of a work machine to intuitively grasp a position of a person existing around the work machine, such a technology has been proposed (for example, see Patent Literature 1) that in a case where it is determined that the person exists in one of monitored spaces (for example, right side of work machine), one of alarm output units (for example, right side alarm output unit in cab) corresponding to the one of monitored spaces outputs an alarm, and that in the case where it is determined that a person exists in another monitored space (for example, behind work machine), another alarm output unit (for example, rear alarm output unit in cab) corresponding to another monitored space outputs an alarm.

### CITATION LIST

### Patent Literature

Patent Literature 1: Japanese Patent Laid-Open No. 2018-093501

### SUMMARY OF INVENTION

### Technical Problem

However, it is desirable for the operator of the work machine to be capable of intuitively grasping not only the presence or absence of an object such as a person around the work machine but also the movement of the object, from the viewpoint of determining an appropriate operation mode of the work machine.

Then, the present invention is directed at providing an apparatus that enables the operator of the work machine to intuitively recognize the movement of the object such as the person around the work machine at an appropriate timing, from the viewpoint of determining the operation mode of the work machine.

### Solution to Problem

A periphery monitoring apparatus for a work machine according to the present invention comprises: a first detection element configured to detect an operation state of an operating device for operating the work machine by an operator; a second detection element configured to detect a position of an object existing around the work machine; a plurality of output devices that are arranged in a plurality of azimuths with reference to a location of the operator in a driving space of the work machine so as to correspond to respective azimuths of a plurality of target spaces with reference to the work machine, and that output an alarm to the operator; a first control element configured to determine a first designated target space that is at least a part of the plurality of target spaces, according to an action mode of the work machine which is predicted from the operation state detected by the first detection element; and a second control element configured to cause a first designated output device among the plurality of output devices, which is arranged in the driving space of the work machine corresponding to an azimuth of the first designated target space with reference to the work machine, to output a different alarm according to a varying mode of a relative position of the object with respect to the work machine, which is determined by a time series of a position of the object detected by the second detection element, in a case where a position of the object detected by the second detection element is included in the first designated target space determined by the first control element.

### BRIEF DESCRIPTION OF DRAWINGS

FIG. 1 shows an explanatory diagram relating to a configuration of a periphery monitoring apparatus for a work machine as an embodiment of the present invention.

FIG. 2 shows a side view of a crawler shovel as the work machine.

FIG. 3 shows a top view of the crawler shovel as the work machine.

FIG. 4 shows an explanatory view relating to an internal space of a cab.

FIG. 5 shows an explanatory view relating to target spaces.

FIG. 6 shows an explanatory diagram relating to a function of the periphery monitoring apparatus for the work machine of a first embodiment.

FIG. 7A shows an explanatory view relating to a first designated target space at the time when an upper revolving body turns counterclockwise.

FIG. 7B shows an explanatory view relating to the first designated target space at the time when the upper revolving body turns clockwise.

FIG. 7C shows an explanatory view relating to the first designated target space at the time when the work machine moves backward.

FIG. 8A shows an explanatory view relating to a plurality of annular spaces and a relative displacement mode of an object to the work machine, as an example.

FIG. 8B shows an explanatory view relating to a plurality of annular spaces, as a modified example.

FIG. 9A shows an explanatory diagram relating to a time-varying mode of an acoustic pressure of an alarm sound.

FIG. 9B shows an explanatory diagram relating to a time-varying mode of a frequency of the alarm sound.

FIG. 9C shows an explanatory diagram relating to a time-varying mode of a cycle of the alarm sound (intermittent sound).

FIG. 10A shows an explanatory diagram relating to a time-varying mode of a relative speed of an object with respect to the work machine.

FIG. 10B shows an explanatory diagram relating to a time-varying mode of the acoustic pressure of the alarm sound.

FIG. 11 shows an explanatory view relating to a displacement mode of an object with respect to the work machine.

FIG. 12 shows an explanatory diagram relating to an azimuth angle of an object with reference to the work machine and the time-varying mode of the alarm sound.

FIG. 13 shows an explanatory diagram relating to a first function of the periphery monitoring apparatus of the work machine of a second embodiment.

FIG. 14 shows an explanatory diagram relating to a second function of the periphery monitoring apparatus of the work machine of the second embodiment.

FIG. 15A shows an explanatory view relating to separation of an object around the work machine.

FIG. 15B shows an explanatory view relating to an approach of the object around the work machine.

FIG. 16A shows an explanatory diagram relating to a time-varying mode of a sound frequency as an output mode of an alarm.

FIG. 16B shows an explanatory diagram relating to a time-varying mode of an acoustic pressure level as the output mode of the alarm.

FIG. 16C shows an explanatory diagram relating to a time-varying mode of a light frequency as the output mode of the alarm.

FIG. 16D shows an explanatory diagram relating to a time-varying mode of luminance as the output mode of the alarm.

### DESCRIPTION OF EMBODIMENTS

(Configuration)

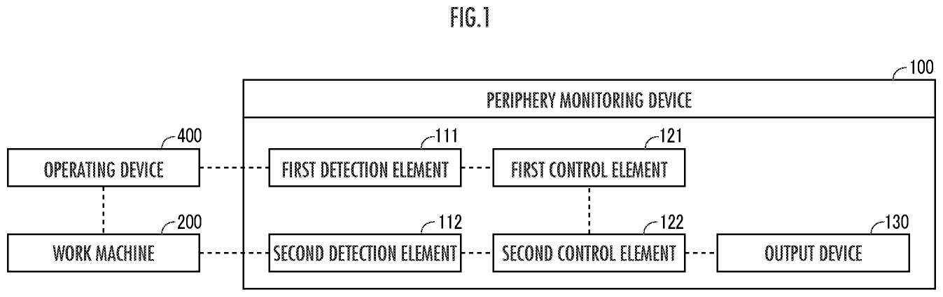

A periphery monitoring apparatus 100 for a work machine according to an embodiment of the present invention shown in FIG. 1 is configured to monitor a situation around the work machine 200, and output an alarm to an operator who operates the work machine 200 through an operating device 400, according to the situation. The periphery monitoring apparatus 100 for the work machine comprises a first detection element 111, a second detection element 112, a first control element 121, a second control element 122, and a plurality of output devices 130.

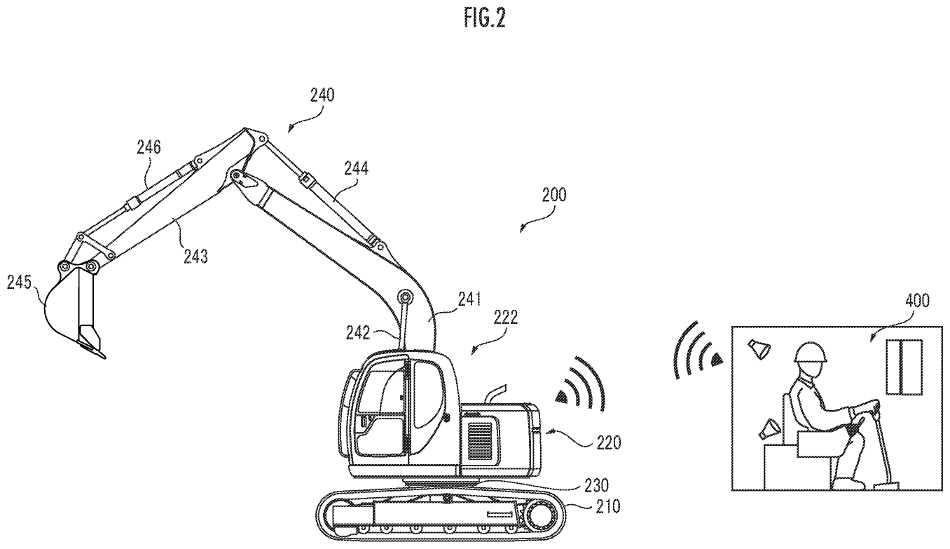

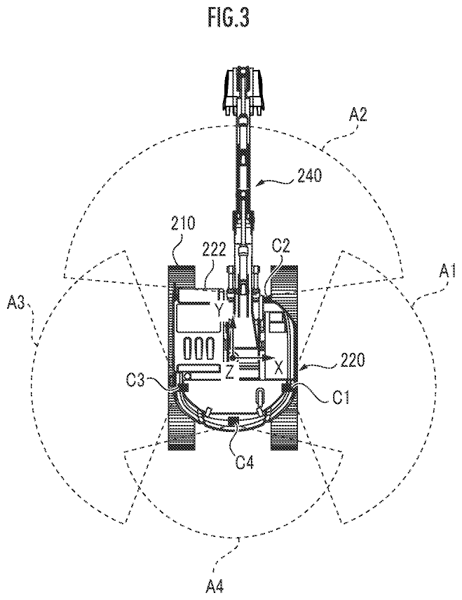

The work machine 200 is, for example, a crawler shovel (construction machine), and as shown in FIG. 2 and FIG. 3, comprises a crawler-type lower traveling body 210, and an upper revolving body 220 that is mounted on the lower traveling body 210 so as to be capable of revolving via a revolving mechanism 230. A cab (driver's cabin) 222 is provided on the front left side of the upper revolving body 220. A work attachment 240 is provided at a front central portion of the upper revolving body 220.

The work attachment 240 comprises: a boom 241 that is mounted on the upper revolving body 220 so as to be capable of rising and falling; an arm 243 that is rotatably coupled to a distal end of the boom 241; and a bucket 245 that is rotatably coupled to a distal end of the arm 243. A boom cylinder 242, an arm cylinder 244 and a bucket cylinder 246, which are each composed of an expandable hydraulic cylinder, are attached to the work attachment 240.

The boom cylinder 242 is interposed between the boom 241 and the upper revolving body 220 so as to expand and contract by receiving the supply of the hydraulic oil, and rotate the boom 241 in a rising and falling direction. The arm cylinder 244 is interposed between the arm 243 and the boom 241 so as to expand and contract by receiving the supply of the hydraulic oil and rotate the arm 243 around a horizontal axis with respect to the boom 241. The bucket cylinder 246 is interposed between the bucket 245 and the arm 243 so as to expand and contract by receiving the supply of the hydraulic oil and rotate the bucket 245 around the horizontal axis with respect to the arm 243.

The operating device 400 includes a travel operating device, a revolution operating device, a boom operating device, an arm operating device, and a bucket operating device. Each operating device has an operating lever that receives a rotation operation. An operating lever (travel lever) of the travel operating device is operated in order to move the lower traveling body 210. The travel lever may also serve as a travel pedal. For example, the travel pedal may be provided which is fixed to a base part or a lower end of the travel lever. An operating lever (revolving lever) of the revolution operating device is operated in order to move a hydraulic type revolving motor which constitutes the revolving mechanism 230. An operating lever (boom lever) of the boom operating device is operated in order to move the boom cylinder 242. An operating lever (arm lever) of the arm operating device is operated in order to move the arm cylinder 244. An operating lever (bucket lever) of the bucket operating device is operated in order to move the bucket cylinder 246. The operating device 400 comprises a wireless communication device for communicating with a real machine side wireless communication device which is mounted on the work machine 200, through a wireless system.

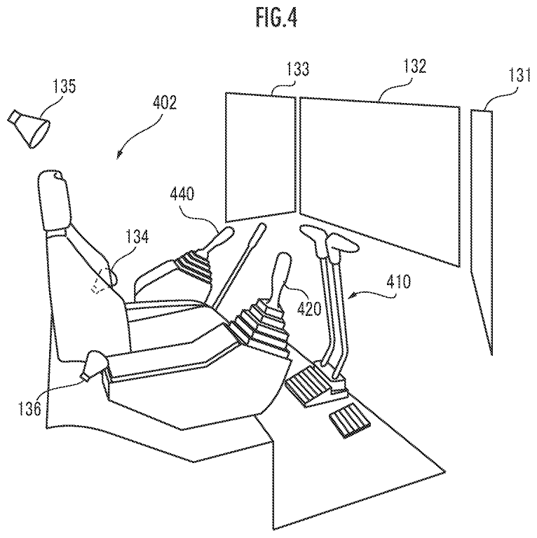

Each operating lever that constitutes the operating device 400 is provided around a seat 402 on which an operator sits in a remote operation room. For example, as shown in FIG. 4, a pair of left and right travel levers 410 corresponding to left and right crawlers may be arranged side by side on the left and right, respectively, in front of the seat 402. The seat 402 is in a form of a high-back chair with an armrest, but may be in any form in which an operator can sit, such as in a form of a low-back chair without a headrest, or in a form of a chair without a backrest.

A cab 222 is provided with an actual machine side operating lever that corresponds to an operating lever provided in the remote operation room, and a drive mechanism or a robot that receives a signal corresponding to an operation mode of each operating lever from the remote operation room, and moves the actual machine operating lever on the basis of the received signal. The actual machine side operating lever may be directly operated by an operator existing in the cab 222. In other words, the operating device 400 may include: the actual machine operating lever; and a remote-control valve that outputs a pilot pressure having a magnitude corresponding to an operation amount of the actual machine operating lever, from a port corresponding to an operation direction. In this case, the operating device 400 may be configured so as to be capable of communicating with the work machine 200 through a wired system instead of the wireless system.

One operating lever may also serve as a plurality of operating levers. For example, the right side operating lever 420 provided in front of the right side frame of the seat 402 shown in FIG. 4 may function as a boom lever when having been operated in the front-rear direction, and function as a bucket lever when having been operated in the left-right direction. Similarly, the left side operating lever 440 provided in front of the left side frame of the seat 402 shown in FIG. 4 may function as an arm lever when having been operated in the front-rear direction, and function as a revolving lever when having been operated in the left-right direction. The lever pattern may be arbitrarily changed by an operation instruction of the operator.

The first detection element 111 detects an operation state of the operating device 400 for operating the work machine 200, by the operator. The first detection element 111 includes: a sensor that is configured to output a signal corresponding to a deformation amount or a displacement amount of an urging mechanism which includes a spring or an elastic member acting so as to restore the operating lever to an original position and attitude corresponding to the operation amount 0; and an arithmetic processing unit that estimates that the revolving lever has been operated in order to revolve the upper revolving body 220 at a certain speed in the counterclockwise direction when viewed from above, on the basis of an output signal of the sensor, and in addition, that the boom, the arm, the bucket and the like have been operated.

The first detection element 111 may include: a pilot pressure sensor that outputs a signal according to the pilot pressure according to the operation amount of the actual machine side operating lever; and an arithmetic processing unit that estimates that the revolving lever has been operated in order to revolve the upper revolving body 220 at a certain speed in the counterclockwise direction when viewed from above, on the basis of an output signal of the pilot pressure sensor, and in addition, that the boom, the arm, the bucket and the like have been operated.

The second detection element 112 detects the position of an object existing around the work machine 200. The second detection element 112 includes: a right side sensor C1, a front sensor C2, a left side sensor C3 and a rear sensor C4, which are arranged on a right side, a front side, a left side and a rear side of the upper revolving body 220, respectively; and an arithmetic processing unit that specifies an actual spatial position of an object in the work machine coordinate system (X, Y, Z) (see FIG. 3), of which the position and attitude are fixed with respect to the upper revolving body 220, on the basis of output signals from the respective sensors C1 to C4. Each of the sensors C1 to C4 is composed of, for example, a TOF type of distance image sensor. Each of the sensors C1 to C4 may be composed of, in addition to the distance image sensor, an image pickup device such as a CCD camera, which can sense an image of which the pixel value is a physical quantity other than the distance, such as luminance and color.

The three-dimensional position in each sensor coordinate system of the object existing in the pixel position is determined, on the basis of the pixel position and the pixel value (distances) in the three-dimensional distance image that has been obtained by each of the sensors C1 to C4. The three-dimensional position of the object in the work machine coordinate system is obtained according to a coordinate transformation operator (rotation matrix or quaternion) that represents the position and attitude of each sensor C1 to C4 in the work machine coordinate system, on the basis of the three-dimensional position of the object in each sensor coordinate system.

Each of the sensors C1 to C4 acquires a distance image of an object existing in each of a right side detection target space A1, a front detection target space A2, a left side detection target space A3 and a rear detection target space A4 which extend in a right side, a front side, a left side and a rear side of the upper revolving body 220 shown in FIG. 3, and form a substantially fan-shaped columnar shape. Each of the right side detection target space A1 and the left side detection target space A3 desirably partially overlap with each of the front detection target space A2 and the rear detection target space A4, but may not overlap with each other.

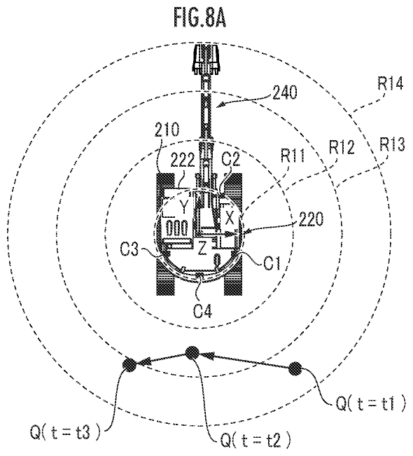

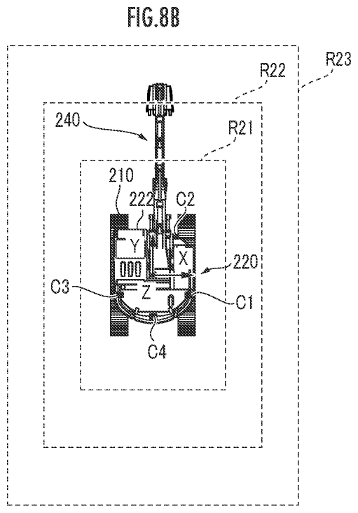

For example, when the upper revolving body 220 revolves counterclockwise around the Z-axis, there is a high possibility that the upper revolving body 220 comes into contact with an object existing in spaces diagonally left front and diagonally right rear of the upper revolving body 220 (see FIG. 8A). When the upper revolving body 220 revolves clockwise around the Z-axis, there is a high possibility that the upper revolving body 220 comes into contact with an object existing in spaces diagonally right front and diagonally left rear of the upper revolving body 220 (see FIG. 8B). When the work machine 200 moves backward, there is a high possibility that the work machine 200 comes into contact with an object existing in a space behind the work machine 200 (see FIG. 8C).

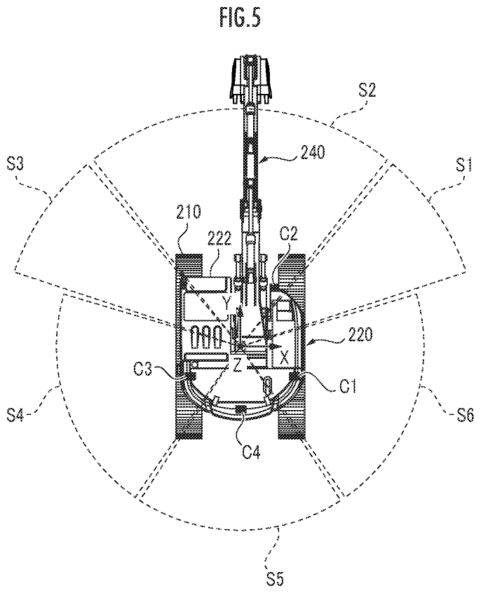

In view of these facts, in the present embodiment, as shown in FIG. 5, a diagonally right front target space S1, a front target space S2, an diagonally left front target space S3, a diagonally left rear target space S4, a rear target space S5 and a diagonally right rear target space S6, which extend in a substantially fan-shaped columnar shape with reference to a diagonally right front, front, diagonally left front, diagonally left rear, rear and diagonally right rear of the upper revolving body 220 are defined as “a plurality of target spaces”. Respective extension modes (equations representing one or a plurality of boundary surfaces (planes or curved surfaces)) of the target spaces S1 to S6 in the work machine coordinate system (X, Y, Z) are stored in a storage device. Each of the upper surface and the lower surface of the substantially fan-shaped column corresponding to each space may be a horizontal surface (plane parallel to X-Y plane) or an inclined surface. The Z coordinate values of the respective centers of gravity of the upper surface and the lower surface of the substantially fan-shaped column corresponding to each of the spaces may be the same or different.

The plurality of output devices 130 are arranged in diagonally right front, front, diagonally left front, diagonally left rear, rear, and diagonally right rear, with reference to the seat portion of the seat 402 (location of operator) on which an operator is seated in a remote operation room (or an internal space of a cab 222), which is a driving space of the work machine 200, as an diagonally right front output device 131, a front output device 132, an diagonally left front output device 133, an diagonally left rear output device 134, a rear output device 135 and an diagonally right rear output device 136, so as to correspond to an azimuth of each of the plurality of target spaces S1 to S3, with reference to the work machine 200. The output devices 131 to 133 include each an image output device such as a display, and an audio output device such as a speaker, for example, and output each an alarm to an operator by an image and a sound. The output devices 134 to 136 include each an audio output device such as a speaker, for example, and each output an alarm to the operator by a sound.

The first control element 121 determines a first designated target space that is at least a part of the plurality of target spaces, according to an action mode of the work machine 200 which is predicted from the operation state detected by the first detection element 111.

The second control element 122 is configured to cause a first designated output device among the plurality of output devices 130, which is arranged in a driving space of the work machine 200 corresponding to an azimuth of the first designated target space with reference to the work machine 200, to output a different alarm according to a varying mode of a relative position of the object with respect to the work machine 200, which is determined by the time series of the position of the object detected by the second detection element 112, in a case where a position of the object detected by the second detection element 112 is included in the first designated target space determined by the first control element 121.

Each of the first control element 121 and the second control element 122 is composed of a common or separate arithmetic processing unit (single-core processor, or multi-core processor or processor core constituting the multi-core processor); and reads necessary data and software from a storage device such as a memory, executes the arithmetic processing according to the software, which regards the data as an object, and outputs the arithmetic processing result.

(Function)

The function of the periphery monitoring apparatus 100 for the work machine having the above configuration will be described below.

(First Embodiment)

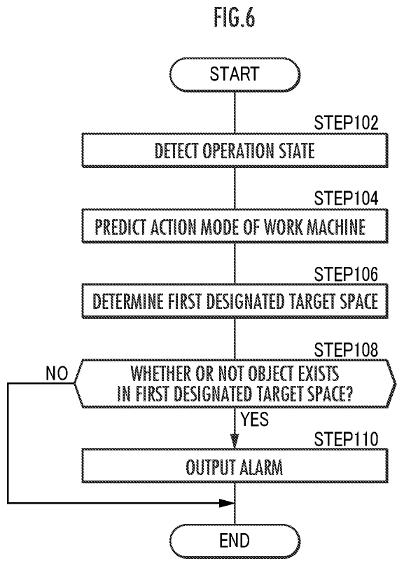

The first detection element 111 detects an operation state of the operating device 400 for operating the work machine 200 by the operator (FIG. 6/STEP 102). For example, it is detected that the revolving lever has been operated in order to revolve the upper revolving body 220 counterclockwise or clockwise when viewed from above, at a certain speed, according to the operation amount of the revolving lever.

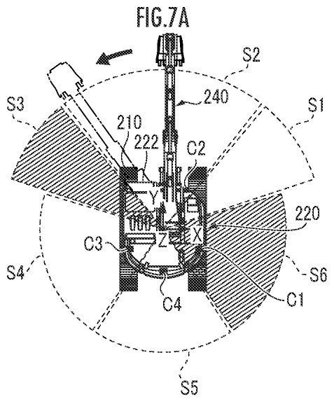

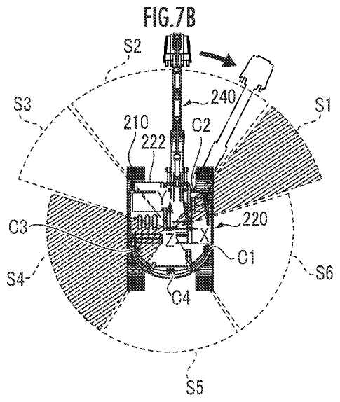

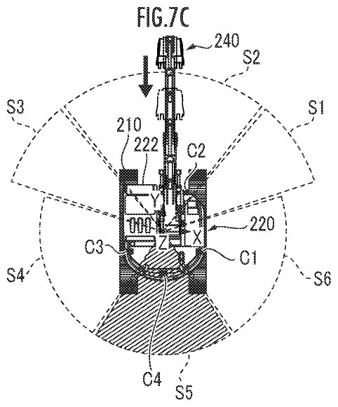

The first control element 121 predicts an action mode of the work machine 200, on the basis of the operation state detected by the first detection element 111 (FIG. 6/STEP 104). For example, as shown by the black arrow in FIG. 7A, according to the operation state of the revolving lever, it is predicted as the action mode of the work machine 200 that the upper revolving body 220 revolves at a certain speed in the counterclockwise direction when viewed from above. As shown by the black arrow in FIG. 7B, according to the operation state of the revolving lever, it is predicted as the action mode of the work machine 200 that the upper revolving body 220 revolves at a certain speed in the clockwise direction when viewed from above. As shown by the black arrow in FIG. 7C, according to the operation state of the travel lever, it is predicted as the action mode of the work machine 200 that the lower traveling body 210 moves backward at a certain speed, and that eventually the work machine 200 as a whole moves backward at a certain speed.

The first control element 121 determines a part of the plurality of target spaces as the first designated target space, on the basis of the prediction result of the action mode of the work machine 200 (FIG. 6/STEP 106). For example, when it has been predicted that the upper revolving body 220 revolves at a certain speed in the counterclockwise direction when viewed from above, at least one of the diagonally left front target space S3 and the diagonally right rear target space S6 of the upper revolving body 220 among the plurality of target spaces S1 to S6 is determined to be the first designated target space (see FIG. 7A). When it has been predicted that the upper revolving body 220 revolves at a certain speed in the clockwise direction when viewed from above, at least one of the diagonally right front target space S1 and the diagonally left rear target space S4 among the plurality of target spaces S1 to S6 is determined to be the first designated target space (see FIG. 7B). When it has been predicted that the work machine 200 moves backward at a certain speed, the rear target space S5 among the plurality of target spaces S1 to S6 is determined to be the first designated target space (see FIG. 7C). However, all of the plurality of target spaces may be determined as the first designated target space.

The second control element 122 determines whether or not the position of the object, which has been detected by the second detection element 112, is included in the first designated target space that has been determined by the first control element 121 (FIG. 6/STEP 108).

When it has been determined that the position of the object is not included in the first designated target space (FIG. 6/STEP 108 . . . NO), a series of processes in a control cycle at this time ends. When it has been determined that the position of the object is included in the first designated target space (FIG. 6/STEP 108 . . . YES), the second control element 122 causes the first designated output device to output an alarm (FIG. 6/STEP 110).

The output mode of the alarm is differentiated according to at least one difference among a relative distance between the object and the work machine 200, a varying rate of the relative distance, a relative azimuth of the object to the work machine 200, and a varying rate of the relative azimuth.

As shown in FIG. 8A, a plurality of annular regions R11 to R14 are defined that have concentric annular shapes which regard a revolution axial line of the upper revolving body 220 with respect to the lower traveling body 210, as a reference point. The output mode of the alarm may be controlled so that the level (ease of recognition, or attention calling power) of the alarm to be output from the output device 130 or the first designated output device becomes high as the annular region in which the object exists among the plurality of annular regions R11 to R14 is closer to the reference point.

For example, as shown in FIG. 8B, a plurality of annular regions R21 to R23 are defined that have concentric rectangular annular shapes which regard the revolution axial line of the upper revolving body 220 with respect to the lower traveling body 210, as the reference point. A plurality of annular regions may be defined so that the seat portion of the seat 402 (location of the operator) on which the operator sits becomes a reference point, in the remote operation room (or internal space of cab 222) which is the driving space of the work machine 200.

Here, a case will be considered where an object Q exists in a right rear position of the work machine 200, which is included in the annular region R14, at the time t=t1, exists in a position behind the work machine 200, which is included in the annular region R13, at the time t=t2, and has moved so as to exist in a left rear position of the work machine 200, which is included in the annular region R14, at the time t=t3 (see FIG. 8A/arrow Q(t=t1)→Q(t=t2) and arrow Q(t=t2)→Q(t =t3)). In this case, in a period t=t1 to t2, a distance between the work machine 200 and the object Q gradually decreases, and in a period t=t2 to t3, the distance between the work machine 200 and the object Q gradually increases.

In this case, in the period t=t1 to t2, the distance between the work machine 200 and the object Q is gradually narrowed, and in response to the situation, an alarm level gradually increases (for example, from the lower limit value). On the other hand, in the period t=t2 to t3, the distance between the work machine 200 and the object Q gradually increases, and in response to the situation, the alarm level gradually decreases (for example, to the lower limit value). At least one element of an acoustic pressure, a frequency and an intermittent cycle of the alarm sound is controlled according to a varying mode of the distance.

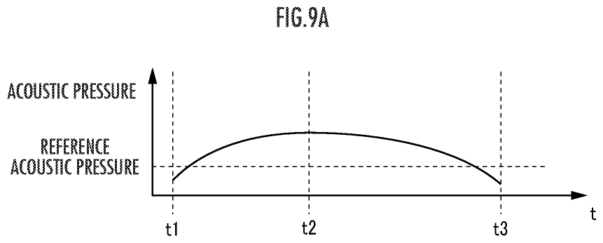

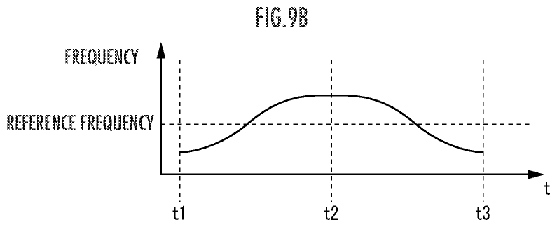

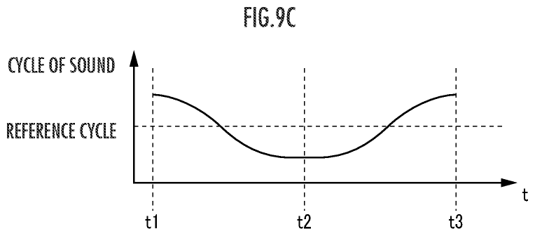

When a level of the alarm level is expressed by a level of the “acoustic pressure (or volume of the alarm sound)”, as shown in FIG. 9A, the acoustic pressure of the alarm gradually increases to exceed the reference acoustic pressure on the way, in the period t=t1 to t2, and on the other hand, gradually decreases to fall below the reference acoustic pressure on the way, in the period t=t2 to t3. In order to enable the operator to intuitively recognize the correlation between the level of the acoustic pressure of the alarm and the relative position of the object Q with respect to the work machine 200, the level of the acoustic pressure of the alarm is set or controlled according to whether the distance between the work machine 200 and the object Q is wide or narrow. An alarm may be set to be output at a reference acoustic pressure, when the object Q exists in a position corresponding to an intermediate distance between the maximum distance and the minimum distance which are each distance between the reference point in the work machine 200 and the position of the distal end of the work attachment 240 or the bucket 245.

When a level of the alarm level is expressed by a level of the “frequency of alarm sound”, as shown in FIG. 9B, the frequency of the alarm sound gradually increases to exceed the reference frequency on the way, in the period t=t1 to t2, and on the other hand, gradually decreases to fall below the reference frequency on the way, in the period t=t2 to t3. An alarm sound of the reference frequency may be set to be output, when the object Q exists in a position corresponding to an intermediate distance between the maximum distance and the minimum distance which are each distances between the reference point in the work machine 200 and the position of the distal end of the work attachment 240 or the bucket 245.

When the level of the alarm level is expressed by a length of an “intermittent cycle of the alarm sound”, as shown in FIG. 9C, the intermittent cycle of the alarm sound gradually becomes shorter than the reference cycle on the way in the period t=t1 to t2, and on the other hand, gradually becomes longer so as to exceed the reference cycle on the way in the period t=t2 to t3. The alarm sound may be set to be output at the reference cycle, when the object Q exists in a position corresponding to an intermediate distance between the maximum distance and the minimum distance which are each distances between the reference point in the work machine 200 and the position of the distal end of the work attachment 240 or the bucket 245.

In addition to or in place of the alarm sound, an alarm in a form of light may be output that is emitted from a light-emitting element or a light-emitting device having a light-emitting element, such as an alarm lamp For example, at least one element of a wavelength (color), a luminance (brightness), and a blinking cycle (switching frequency between bright and dark periods) of light which is emitted from the alarm lamp may be varied according to the distance between the work machine 200 and the object Q.

In addition, a relative speed V of the object with respect to the work machine 200 is obtained on the basis of a displacement mode of a time series of a previous position of the object (detected position in previous control cycle) or a position over a predetermined period before the previous time and a position of the object at this time. A relative speed V of the object with respect to the work machine 200 may be determined in additional consideration of a relative varying mode of one of a position and an attitude of the work machine coordinate system in the world coordinate system, according to an action state of the work machine 200 such as the translation of the work machine 200 and the revolution of the upper revolving body 220.

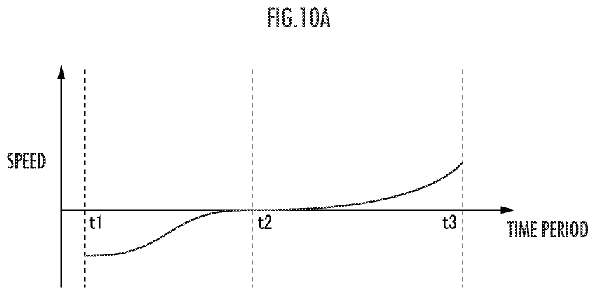

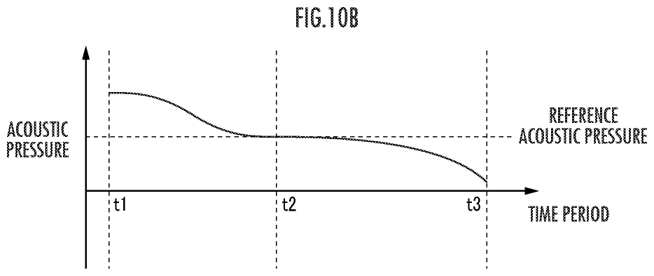

When the object Q moves as illustrated in FIG. 8A, the relative speed of the object Q with respect to the work machine 200 varies as shown in FIG. 10A. In other words, in a period [t1, t2], the relative speed of the object Q with respect to the work machine 200 gradually decreases its value from a negative value (state in which the object Q approaches the work machine 200), and reaches 0. In a period [t2, t3], the relative speed of the object Q with respect to the work machine 200 gradually increases from 0 to a positive value (state in which the object Q moves away from work machine 200).

When the speed of the object Q varies as shown in FIG. 10A, the alarm level decreases from the maximum value, in the period [t1, t2], and the decreasing rate gradually decreases. On the other hand, the alarm level decreases in the period [t2, t3], and the decreasing rate gradually increases.

In the case where the alarm level is expressed by the acoustic pressure, as shown in FIG. 10B, the acoustic pressure decreases from the maximum acoustic pressure to the reference acoustic pressure in the period [t1, t2], and decreases from the reference acoustic pressure to the minimum acoustic pressure in the period [t2, t3]. Also in the case where the alarm level is expressed by the frequency of sound, an interval between intermittent sounds, the frequency of light, or the blinking cycle of light, the alarm level may be adjusted in the same manner as in the above description.

In addition, tone colors of the alarm of the respective designated output devices corresponding to the target spaces S1 to S6 may be configured to be different from each other. For example, it is accepted to adopt a first tone color (example; beep sound) as the alarm sound when the object is positioned in a space on the right side of the work machine 200, and to adopt a second tone color (example: whistle sound) as the alarm sound when the object is positioned in a space on the left side of the work machine 200. It is possible to distinguish in which target space the object is positioned, according to the tone color. In addition, a third tone color may be assigned to the rear of the work machine 200.

The tone color may be configured to be different according to the relative distance which is determined by the relative position of the object with respect to the work machine 200. For example, as shown in additional FIG. 1, in a case where the plurality of annular regions R11 to R14 are defined that have concentric annular shapes which regard the revolution axial line of the upper revolving body 220 with respect to the lower traveling body 210 as a reference point, an alarm can be configured to be added more when an object exists in an annular space closer to the reference point among the plurality of annular spaces. For example, when the object is positioned outside R14, an alarm is issued only with a first tone color, and when the object approaches the R13 of the inside, an alarm of a second tone color is also issued in addition to the first tone color. This method can issue an alarm for an approaching degree of the object by an overlapping condition of the tone colors.

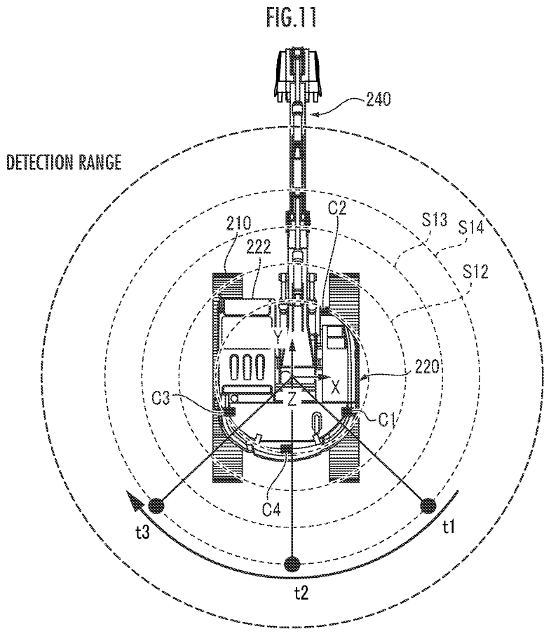

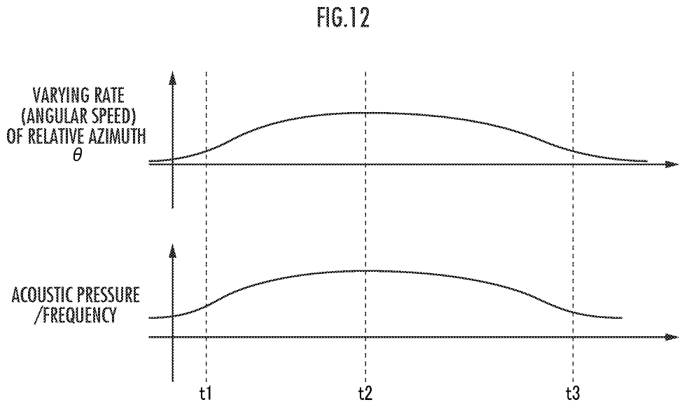

When the object Q moves along an arc around the revolution axial line of the upper revolving body 220 with respect to the lower traveling body 210, as shown in FIG. 11, a relative distance between the work machine 200 and the object Q and the relative speed do not vary, and accordingly when the moving speed of the object Q is high, another unit of enhancing the alarm becomes necessary. In this case, as shown in the lower part of FIG. 12, the acoustic pressure or frequency of the alarm sound may be adjusted so as to vary according to an increase or decrease in an azimuth angle speed of the object Q, as shown in the upper part of FIG. 12.

(Effect of Operation)

At least a part of the plurality of target spaces is defined as the “first designated target space”, according to the action mode of the work machine 200, which is predicted on the basis of the operation state by the operator in the operating device 400 of the work machine 200 (see FIG. 6/STEP 102 to STEP 106, and FIG. 7A to FIG. 7C). When the position of the object is included in the first designated target space, an alarm is output by the first designated output device, and the alarm is differentiated according to the varying mode of the relative position between the work machine 200 and the object (see FIG. 6/STEP 110, FIG. 8A, FIG. 8B, FIG. 9A, FIG. 9B, FIG. 9C, FIG. 10A, FIG. 10B, FIG. 11 and FIG. 12). The first designated output device is arranged in an azimuth corresponding to the azimuth of the first designated target space with reference to the work machine 200, with reference to the location of the operator (the position of the seat 402) in a driving space of the work machine 200 (see FIG. 4).

Thereby, when an operator sitting on the seat 402 in the driving space of the work machine 200 operates the operating device 400, and when an alarm is output by the first designated output device, the periphery monitoring apparatus enables the operator to intuitively recognize that the object exists in the movement direction of the work machine 200 corresponding to the operation state. The periphery monitoring apparatus causes the first designated output device to output an alarm in a different mode according to a difference in a varying mode of a distance between the work machine 200 and the object Q, which is determined according to a relative position between the work machine 200 and the object Q. Thereby, the periphery monitoring apparatus enables the operator to intuitively recognize a varying mode of the distance between the work machine 200 and the object, for example, a difference between whether the object is relatively approaching or relatively moving away, according to a difference in the alarm output by the first designated output device.

When the distance between the work machine 200 and the object is decreasing, the alarm level can be set so as to become high. When the distance between the work machine 200 and the object is increasing, the alarm level can be set so as to become low.

The periphery monitoring apparatus 100 for the work machine having the configuration enables the operator to intuitively recognize the difference between whether the work machine 200 and the object relatively approach or move away from each other, according to the difference in the varying mode of the alarm output by the first designated output device.

When the relative speed of the object to the work machine 200 is small (approaching), the alarm level can be set so as to become high. When the relative speed of the object to the work machine 200 is large (moving away), the alarm level can be set so as to become low.

The periphery monitoring apparatus 100 for the work machine having the configuration enables the operator to intuitively recognize the difference in the relative speed of the object with respect to the work machine 200, according to the difference in the varying mode of the sound of the alarm output by the first designated output device.

In the above embodiment, a unit of giving one type of alarm by one alarm unit has been described. In the case of the alarm sound, one type of alarm is issued by any of the acoustic pressure, the frequency and the distance, and in addition, in the case of the warning lamp, another type of alarm is further issued by the wavelength, the luminance and the cycle.

On the other hand, it is also acceptable to issue a plurality of alarms with the use of a plurality of elements which the alarm unit has. The examples include a case of warning of the relative distance of the object with respect to the work machine 200 by the acoustic pressure of the alarm sound, and warning of the relative speed of the object by the frequency of the alarm sound. When the plurality of alarms are issued in this way, the operator can recognize the plurality of alarms with only one alarm (alarm sound). It is also possible to cause the other alarm unit (alarm lamp) to take charge of another alarm. In addition, the correspondence between the alarm element of the alarm unit and the alarm content can be appropriately determined.

In the above embodiment, the alarm has been configured to be continuously varied according to the distance or the speed, but may not be continuous. For example, the alarms may be limited to some simple alarms

(Second Embodiment)

(Function)

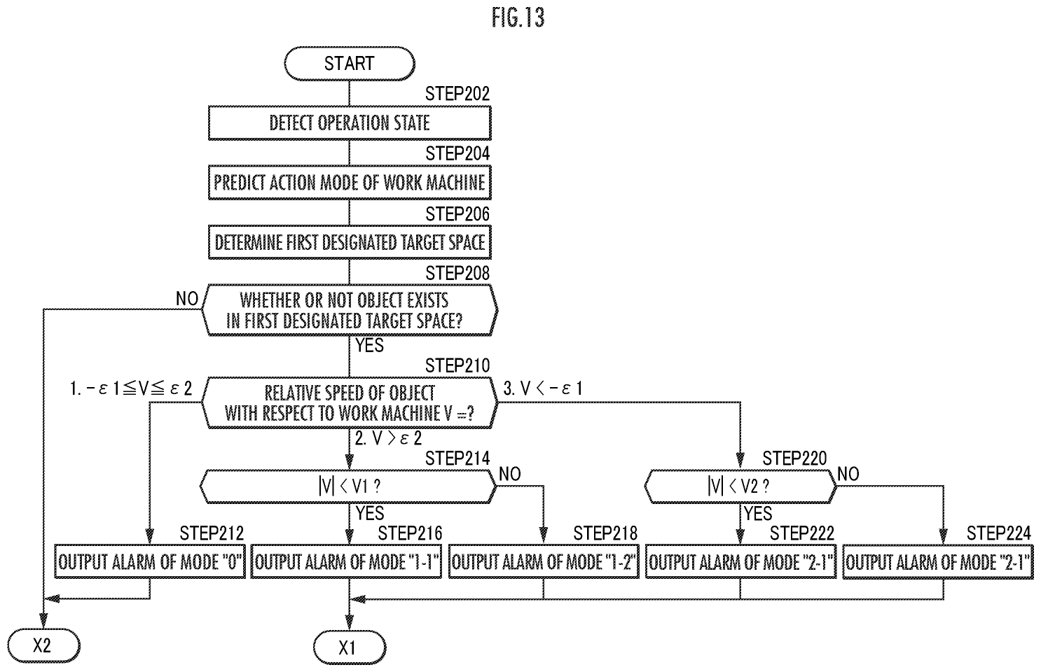

The first detection element 111 detects an operation state of the operating device 400 for operating the work machine 200 by the operator (FIG. 13/STEP 202). For example, it is detected that the revolving lever has been operated in order to revolve the upper revolving body 220 counterclockwise or clockwise when viewed from above, at a certain speed, according to the operation amount of the revolving lever.

The first control element 121 predicts an action mode of the work machine 200, on the basis of the operation state detected by the first detection element 111 (FIG. 13/STEP 204). For example, the action mode of the work machine 200 is predicted according to the operation state of the revolving lever, in the same manner as in the example of the first embodiment (see FIG. 7A to FIG. 7C).

The first designated target space that is at least a part of the plurality of target spaces is determined by the first control element 121, on the basis of the prediction result of the action mode of the work machine 200 (FIG. 13/STEP 206). For example, as in the example of the first embodiment, at least one target space among the plurality of target spaces S1 to S6 is determined as the first designated target space (see FIG. 7A to FIG. 7C).

The second control element 122 determines whether or not the position of the object, which has been detected by the second detection element 112, is included in the first designated target space that has been determined by the first control element 121 (FIG. 13/STEP 208).

When it has been determined that the position of the object is not included in the first designated target space (FIG. 13/STEP 208 . . . NO), a series of processes in a control cycle at this time ends. In a case where it is determined that the position of the object is included in the first designated target space (FIG. 13/STEP 208 . . . YES), the second control element 122 determines whether the relative speed V of the object with respect to the work machine 200 is −ε₁≤V≤ε₂, 0<ε₂<V, or V<−ε₁<0 (FIG. 13/STEP 210).

A case where the relative speed V of the object with respect to the work machine 200 is “−ε₁≤V≤ε₂” corresponds to the case where the object Q does not substantially move with respect to the work machine 200; a case of being “ε₂<V” (a case where V exceeds a positive value E₂) corresponds to the case where the object Q is moving away from the work machine 200; and the case where “V<−ε₁” (a case where V is smaller than a negative value −ε₁) corresponds to the case where the object Q is approaching the work machine 200. For example, ε₁ and ε₂ are set according to the relational expression 0≤ε₁<ε₂, where ε₁=0.5 km/h and ε₂=0.5 km/h.

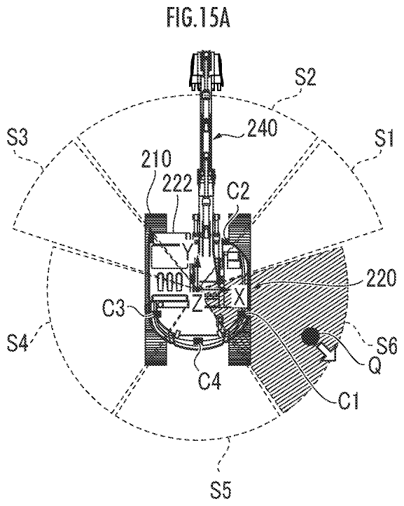

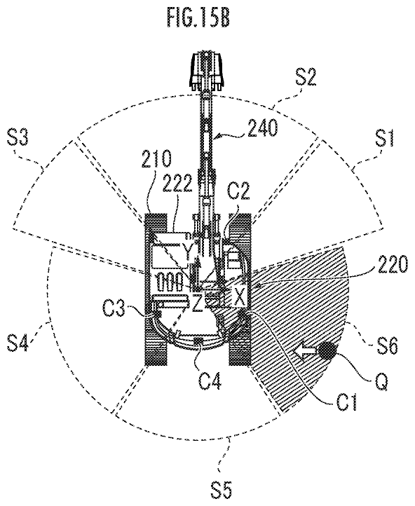

The case of being ε₂<V corresponds to a state in which the object Q in the first designated target space (diagonally right rear target area S6) is separated from the work machine 200, as shown in FIG. 15A. The case of being V<−ε₁ corresponds to a state in which the object Q in the first designated target space (diagonally right rear target area S6) is approaching the work machine 200, as shown in FIG. 15B.

The relative speed V of the object with respect to the work machine 200 is obtained on the basis of the displacement mode of the displacement mode of the previous position of the object (detected position in previous control cycle) or the position over a predetermined period before the previous time and the position of the object at this time. The relative speed V of the object with respect to the work machine 200 may be determined in additional consideration of the relative varying mode of one of the position and the attitude of the work machine coordinate system in the world coordinate system, according to the action state of the work machine 200 such as the translation of the work machine 200 and the revolution of the upper revolving body 220.

In a case where it is determined that the relative speed V of the object with respect to the work machine 200 satisfies −ε₁≤V≤ε₂ (FIG. 13/STEP 210 . . . 1), the second control element 122 causes the first designated output device among the plurality of output devices 130 to output an alarm of the mode “0” (FIG. 13/STEP 212). The “first designated output device” is an output device arranged in the driving space of the work machine 200 so as to correspond to the azimuth of the first designated target space with reference to the work machine 200, among the plurality of output devices 130. For example, when the first designated target space is the diagonally right rear target space S6, the diagonally right rear output device 136 outputs an alarm as the first designated output device (see FIG. 4 and FIG. 5). When the first designated target space is the diagonally left rear target space S4, the diagonally left rear output device 134 outputs an alarm as the first designated output device. When the first designated target space is the rear target space S5, the rear output device 135 outputs an alarm as the first designated output device.

When it has been determined that the relative speed V of the object with respect to the work machine 200 satisfies ε₂<V (FIG. 13/STEP 210 . . . 2), the second control element 122 determines whether or not the magnitude |V| of the relative speed V is smaller than V₁ (>ε₂) (FIG. 13/STEP 214). When the determination result is positive (FIG. 13/STEP 214 . . . YES), the second control element 122 causes the first designated output device to output an alarm of the mode “1-1” (FIG. 13/STEP 216). When the determination result is negative (FIG. 13/STEP 214 . . . NO), the second control element 122 causes the first designated output device to output the alarm of the mode “1-2” (FIG. 13/STEP 218).

When it has been determined that the relative speed V of the object with respect to the work machine 200 satisfies V<−ε₁ (FIG. 13/STEP 210 . . . 3), the second control element 122 determines whether or not the magnitude |V| of the relative speed V is smaller than V₂ (>ε₁) (FIG. 13/STEP 220). When the determination result is positive (FIG. 13/STEP 220 . . . YES), the second control element 122 causes the first designated output device to output an alarm of the mode “2-1” (FIG. 13/STEP 222). When the determination result is negative (FIG. 13/STEP 220 . . . NO), the second control element 122 causes the first designated output device to output an alarm of the mode “2-2” (FIG. 13/STEP 224).

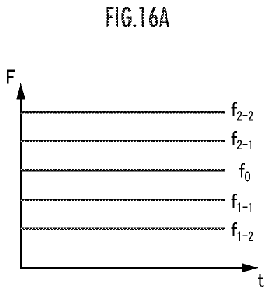

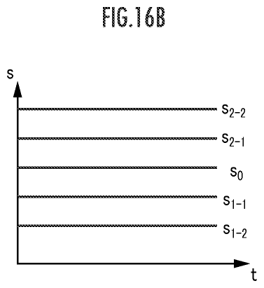

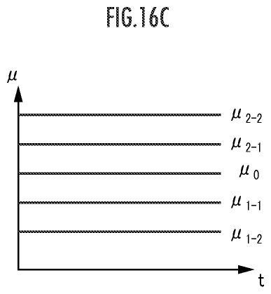

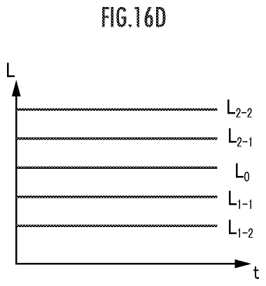

The mode “0”, the mode “1-1”, the mode “1-2”, the mode “2-1” and the mode “2-2” are different from each other. For example, in a case where sound is included in the alarm (in a case where the output device 130 is composed of a sound output device including a piezoelectric element or the like), as shown in FIG. 16A, a sound frequency of the mode 0 is f=f₀(t), which is constant. The mode “1-1”, the mode “1-2”, the mode “2-1” and the mode “2-2” are set at frequencies different from the sound frequency of the mode “0”, which is f=f₀(t). In FIG. 16A to FIG. 16D, time t corresponds to, for example, an alarm cycle, and the output device issues an alarm at each time t. In the alarm other than the mode 0, the sound frequency in the alarm cycle may configured to gradually increase in the case of enhancement, and gradually decrease in the case of declination.

When the relative speed V of the object with respect to the work machine 200 varies, the alarm varies to any one of the mode “0”, the mode “1-1”, the mode “1-2”, the mode “2-1” and the mode “2-2”.

In addition, in the above embodiment, the modes “1-1” and “1-2” and the modes “2-1” and “2-2” have been determined to correspond to two types of alarm levels, respectively, but may be determined to correspond to three or more types of alarm levels. The three or more types of alarm levels can warn of a far-near speed more finely than the case of expressing the far-near speed by two types of alarms

Not only the frequency but also the acoustic pressure and the distance in the case of the alarm sound, and in the case of a warning lamp, the wavelength, the luminance, the cycle and the like may be similarly determined to be several types of alarms.

Due to this configuration, the alarm is issued only by the mode “0”, the mode “1-1”, the mode “1-2”, the mode “2-1” and the mode “2-2”, and accordingly the alarm can be simplified. It becomes possible for the operator to easily grasp the varying mode of the distance between the work machine 200 and the object, due to the simplified alarm.

A decreasing rate of a sound frequency f=f₁₋₂(t) of the mode 1-2 may be adjusted so as to be higher than a decreasing rate of a sound frequency f=f₁₋₁(t) of the mode 1-1. A lower limit of the sound frequency f=f₁₋₂(t) of the mode 1-2 may be adjusted so as to be lower than a lower limit of the sound frequency f=f₁₋₁(t) of the mode 1-1. An increasing rate of a sound frequency f=f₂₋₂(t) of the mode 2-2 may be adjusted so as to be higher than an increasing rate of a sound frequency f=f₂₋₁(t) of the mode 2-1. An upper limit of the sound frequency f=f₂₋₂(t) of the mode 2-2 may be adjusted so as to be higher than an upper limit of the sound frequency f=f₂₋₁(t) of the mode 2-1.

As shown in FIG. 16B, an acoustic pressure level s=s₀(t) of the mode 0 is constant. On the other hand, an acoustic pressure level s=s₁₋₁(t) of the mode 1-1 and an acoustic pressure level s=s₁₋₂(t) of the mode 1-2 may vary so as to gradually decrease from s=s₀(t) to the respective different lower limit values, with time t. An acoustic pressure level s=s₂₋₁(t) of the mode 2-1 and an acoustic pressure level s=s₂₋₂(t) of the mode 2-2 may vary so as to gradually increase from s=s₀(t) to the respective different upper limit values, with time t.

A decreasing rate of the acoustic pressure level s=s₁₋₂(t) of the mode 1-2 may be adjusted to be higher than a decreasing rate of the acoustic pressure level s=s₁₋₁(t) of the mode 1-1. A lower limit of the acoustic pressure level s=s₁₋₂(t) of the mode 1-2 may be adjusted to be lower than a lower limit of the acoustic pressure level s=s₁₋₁(t) of the mode 1-1. An increasing rate of an acoustic pressure level s=s₂₋₂(t) of the mode 2-2 may be adjusted so as to be higher than an increasing rate of an acoustic pressure level s=s₂₋₁(t) of the mode 2-1. An upper limit of the acoustic pressure level s=s₂₋₂(t) of the mode 2-2 may be adjusted to be higher than an upper limit of the acoustic pressure level s=s₂₋₁(t) of the mode 2-1.

For example, when the alarm includes visible light (when the output device 130 is composed of an image output device or a light-emitting element such as an LED), a visible light frequency v=v₀(t) of the mode 0 is constant as shown in FIG. 16C. On the other hand, a visible light frequency v=v₁₋₁(t) of the mode 1-1 and a visible light frequency v=v₁₋₂(t) of the mode 1-2 may vary so as to gradually decrease from v=v₀(t) to the respective different lower limit values, with time t. A visible light frequency v=v₂₋₁(t) of the mode 2-1 and a visible light frequency v=v₂₋₂(t) of the mode 2-2 may vary so as to gradually increase from v=v₀(t) to the respective different upper limit values, with time t.

A decreasing rate of the visible light frequency v=v₁₋₂(t) of the mode 1-2 may be adjusted so as to be higher than a decreasing rate of the visible light frequency v=v₁₋₁(t) of the mode 1-1. A lower limit of the visible light frequency v=v₁₋₂(t) of the mode 1-2 may be adjusted so as to be lower than a lower limit of the visible light frequency v=v₁₋₁(t) of the mode 1-1. An increasing rate of the visible light frequency v=v₂₋₂(t) of the mode 2-2 may be adjusted so as to be higher than an increasing rate of the visible light frequency v=v₂₋₁(t) of the mode 2-1. An upper limit of the visible light frequency v=v₂₋₂(t) of the mode 2-2 may be adjusted so as to be higher than an upper limit of the visible light frequency v=v₂₋₁(t) of the mode 2-1.

As shown in FIG. 16D, luminance L=L₀(t) of the mode 0 is constant. On the other hand, luminance L=L₁₋₁(t) of the mode 1-1 and luminance L=L₁₋₂(t) of the mode 1-2 may vary so as to gradually decrease from L=L₀(t) to the respective different lower limit values, with time t. Luminance L=L₂₋₁(t) of the mode 2-1 and luminance L=L₂₋₂(t) of the mode 2-2 may vary so as to gradually increase from L=L₀(t) to the respective different upper limit values, with time t.

A decreasing rate of the luminance L=L₁₋₂(t) of the mode 1-2 may be adjusted so as to be higher than a decreasing rate of the luminance L=L₁₋₁(t) of the mode 1-1. A lower limit of the luminance L=L₁₋₂(t) of the mode 1-2 may be adjusted so as to be lower than a lower limit of the luminance L=L₁₋₁(t) of the mode 1-1. An increasing rate of the luminance L=L₂₋₂(t) of the mode 2-2 may be adjusted so as to be higher than an increasing rate of the luminance L=L₂₋₁(t) of the mode 2-1. An upper limit of the luminance L=L₂₋₂(t) of the mode 2-2 may be adjusted so as to be higher than an upper limit of the luminance L=L₂₋₁(t) of the mode 2-1.

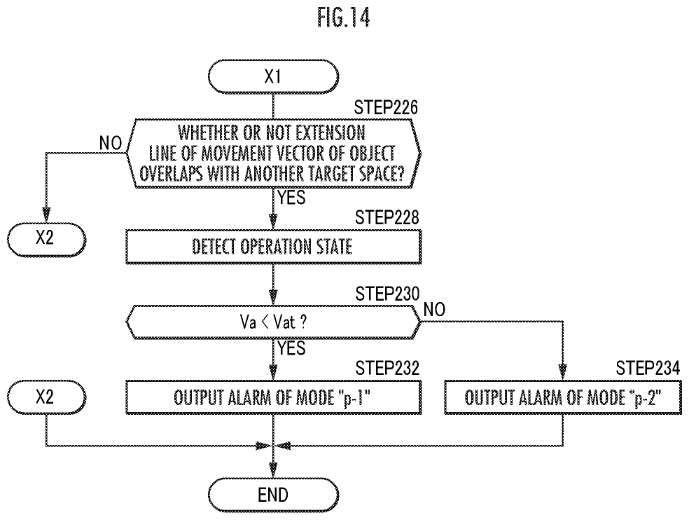

When the alarm has been output according to the modes 1-1, 1-2, 2-1 and 2-2, the second control element 122 determines whether or not the position of the object heads from the first designated target space among the plurality of target spaces to a second designated target space which is another target space (whether or not an extension line of the movement vector of the object overlaps with the another target space) (FIG. 14/STEP 226).

When the determination result is negative (FIG. 14/STEP 226 . . . NO), a series of processes in a control cycle at this time ends. When the determination result is positive (FIG. 14/STEP 226 . . . YES), the second control element 122 determines the another target space as the second designated target space (FIG. 14/STEP 228). For example, in a case where an object existing in the rear target space S5 as the first designated target space is moving toward the diagonally right rear target space S6, the diagonally right rear target space S6 is determined as the second designated target space.

Subsequently, the second control element 122 determines whether or not a speed Va of the object at the actual spatial position is smaller than a reference speed Vat (FIG. 14/STEP 230). When it has been determined that the speed Va of the object at the actual spatial position is smaller than the reference speed Vat (FIG. 14/STEP 230 . . . YES), the second control element 122 causes the second designated output device to output an alarm (secondary alarm), according to a mode p-1 (p=1-1, 1-2, 2-1 and 2-2) (FIG. 14/STEP 232). When it has been determined that the speed Va of the object at the actual spatial position is the reference speed Vat or larger (FIG. 14/STEP 230 . . . NO), the second control element 122 causes the second designated output device to output an alarm according to a mode p-2 (FIG. 14/STEP 234).

The second designated output device is an output device that is arranged in the driving space so as to correspond to the azimuth of the second designated target space with reference to the work machine 200. For example, when the diagonally right rear target space S6 is determined as the second designated target space, the diagonally right rear output device 136 outputs the secondary alarm as the second designated output device.

The relationship between the modes p-1 and p-2 is the same as the relationship between the modes 1-1 and 1-2, or the relationship between the modes 2-1 and 2-2 (see FIG. 16A to FIG. 16D).

(Effect of Operation)

At least a part of the plurality of target spaces is determined as the “first designated target space”, according to the action mode of the work machine 200, which is predicted on the basis of the operation state by the operator in the operating device 400 of the work machine 200 (see FIG. 13/STEPs 202 to 206, and FIG. 7A to FIG. 7C). An action of the work machine 200 is a concept that includes not only the whole actions of the work machine 200 but also an action of an action part which is a part of the whole actions. When the position of the object is included in the first designated target space, an alarm is output by the first designated output device, and the alarm is differentiated according to the varying mode of the relative position between the work machine 200 and the object (see FIG. 13/STEPs 212, 218, 220, 224 and 226, and FIG. 16A to FIG. 16D). The first designated output device is arranged in an azimuth corresponding to the azimuth of the first designated target space with reference to the work machine 200, with reference to the location of the operator (the position of the seat 402) in a driving space of the work machine 200 (see FIG. 4). The “azimuth” is specified not only by a single azimuth angle but also by an azimuth angle range, and may be specified by an elevation angle range.

Thereby, when an operator sitting on the seat 402 in the driving space of the work machine 200 operates the operating device 400, and when an alarm is output by the first designated output device, the periphery monitoring apparatus enables the operator to intuitively recognize that the object exists in the movement direction of the work machine 200 corresponding to the operation state.

The second control element 122 causes the first designated output device to output an alarm in a different mode according to a difference in a varying mode of a distance between the work machine 200 and the object Q, which is determined according to a relative position between the work machine 200 and the object Q (see FIG. 16A to FIG. 16D). Thereby, the second control element 122 enables the operator to intuitively recognize a varying mode of the distance between the work machine 200 and the object, for example, a difference between whether the work machine 200 and the object are relatively approaching or relatively moving away, according to a difference in the alarm output by the first designated output device (see FIG. 15A and FIG. 15B).

The second control element 122 causes the first designated output device to output an enhancing alarm, when the distance between the work machine 200 and the object becomes small, and causes the first designated output device to output a declining alarm, when the distance between the work machine 200 and the object becomes large. Specifically, when the distance between the work machine 200 and the object is narrowing, the second control element 122 causes the first designated output device to output a sound having a relatively high frequency as an alarm (see FIG. 13/STEPs 222 and 224, and FIG. 16A/f₂₋₁(t) and f₂₋₂(t)). When the distance between the work machine 200 and the object is expanding, the second control element 122 causes the first designated output device to output a sound having a relatively low frequency as an alarm (see FIG. 13/STEPs 216 and 218, and FIG. 16A/f₁₋₁(t) and f₁₋₂(t)). Thereby, the second control element 122 enables the operator to intuitively recognize, a difference between whether the work machine 200 and the object are relatively approaching or relatively moving away, according to a difference in the varying mode of the alarm output by the first designated output device. Thereby, the second control element 122 enables the operator to intuitively recognize, a difference between whether the work machine 200 and the object are relatively approaching or relatively moving away, according to a difference between varying modes of the frequencies such as a Doppler effect of the sound which is the alarm output by the first designated output device.

The second control element 122 adjusts the varying rate of the enhancement or the declination of the alarm output by the first designated output device so as to become larger, as the varying rate of the distance between the work machine and the object is larger. Specifically, the larger the varying rate of the distance between the work machine 200 and the object is, the larger the varying rate of the frequency of the sound becomes which is the alarm output by the first designated output device (see FIG. 13/STEPs 214, 216 and 218, and STEPs 220, 222 and 224, and FIG. 16A/f₁₋₁(t), f₁₋₂(t), f₂₋₁(t) and f₂₋₂(t)). Thereby, the second control element 122 enables the operator to intuitively recognize the level of the varying rate of the distance between the work machine and the object, according to the level of the varying rate of the alarm output by the first designated output device.

When the position of the object heads from the first designated target space to the second designated target space which is another target space among the plurality of target spaces, the second control element 122 causes the second designated output device in addition to the first designated output device to output an alarm (see FIG. 14/STEPs 226, 228, 230, 232 and 234). For example, when an object existing in the rear target space S3 as the first designated target space is moving toward the right side target space S1 as the second designated target space of the work machine 200 or the upper revolving body 220, the rear output device 133 outputs a primary alarm, and after the output of the primary alarm has been started, before the output of the primary alarm is completed, or after the output of the primary alarm is completed, the right side output device 131 outputs the secondary alarm. At this time, the second control element 122 may vary a ratio of a period during which the second designated output device is caused to output the alarm to a period during which the first designated output device is caused to output the alarm, according to a level of a moving speed of the object.

Thereby, the second control element enables the operator to intuitively recognize that the object is moving from the first designated target space toward another target space, according to the difference between the alarms output by the first designated output device and the second designated output device. The second control element enables the operator to intuitively recognize that the object is moving from one target space (first designated target space) corresponding to the arranged azimuth of one output device (first designated output device) among the plurality of output devices 131 to 133, in the driving space, which has output an alarm first, toward another target space (second designated target space) corresponding to an arranged azimuth of another output device (second designated output device) in the driving space, which has output an alarm later.

(Other Embodiments of the Present Invention)

The first detection element 111 may detect a transition from a non-interaction state between the operator and the operating device 400 (for example, a state in which the operator does not grip or touch the operating lever) to an interaction state (for example, a state in which the operator grips or touches the operating lever),or a state in which the operator operates the operating device 400 in the dead zone, as the operation state by the operator of the operating device 400. In a case where an operation amount of the operating lever that is not 0 is detected but the magnitude thereof is lower than a threshold value, a transition from the non-interaction state between the operator and the operating device 400 to the interaction state, or a state in which the operator operates the operating device 400 in the dead zone may be detected. Furthermore, provided that the state has been detected by the first detection element 111, the second output device 122 may control the output device 130 so as to be in a state capable of outputting an alarm.

In an initial stage of an operation, in which the work machine 200 does not start its action yet though such a probability is high that the operator intends to operate the work machine 200, the periphery monitoring apparatus 100 for the work machine having the configuration enables an operator to intuitively recognize an existence of an object in a movement direction of the work machine 200 corresponding to the operation of the operating device 400 by the operator, and enables an operator to intuitively recognize a difference in a varying mode of a relative position between the work machine 200 and the object, according to a difference in an alarm.

As shown in FIG. 8A, a plurality of annular regions R11 to R14 having concentric annular shapes may be defined which regard the revolution axial line of the upper revolving body 220 with respect to the lower traveling body 210, as a reference point. As shown in FIG. 8B, a plurality of annular regions R21 to R23 of concentric rectangular annular shapes may be defined which regard the revolution axial line of the upper revolving body 220 with respect to the lower traveling body 210, as a reference point. A plurality of annular regions may be defined so that the seat portion of the seat 402 (location of the operator) on which the operator sits becomes a reference point, in the remote operation room (or internal space of cab 222) which is the driving space of the work machine 200.

A function of confirming a reference alarm may also be mounted. Due to a mode being mounted for confirming the alarm which indicates, for example, an alarm sound frequency when a speed V of the object is 0, or a distance when the object is at a reference position of the distal end bucket, the operator can confirm the reference of the alarm.

The second control element 122 may cause the second designated output device to output an alarm, after having caused the first designated output device to output an alarm.

The periphery monitoring apparatus 100 for the work machine having the configuration enables the operator to intuitively recognize that an object is moving from one target space (first designated target space) corresponding to the arranged azimuth of one output device (first designated output device) among the plurality of output devices 130, in the driving space, which has output an alarm first, toward another target space (second designated target space) corresponding to an arranged azimuth of another output device (second designated output device) in the driving space, which has output an alarm later.

The second control element 122 may vary a ratio of a period during which the second designated output device is caused to output the alarm, to a period during which the first designated output device is caused to output the alarm, according to a level of a moving speed of the object

The periphery monitoring apparatus for the work machine having the configuration enables the operator to intuitively recognize, as described above, that an object is moving from one target space (first designated target space) toward another target space (second designated target space). Furthermore, the periphery monitoring apparatus for the work machine enables the operator to intuitively recognize the level of a moving speed of the object, according to a ratio between an alarm output period by the first designated output device and an alarm output period by the second designated output device.

It is preferable that the second control element 122 causes the first designated output device to output the alarm in which each of a plurality of elements constituting an alarm sound as the alarm is differentiated in a different mode, according to each difference in varying modes of the relative position between the work machine 200 and the object, and the distance between the work machine 200 and the object.

The periphery monitoring apparatus for the work machine having the configuration can simultaneously express a relative position of the object with respect to the work machine 200 and a varying mode thereof by one alarm unit, and enables the operator to intuitively recognize the relative position and the varying mode.

### REFERENCE SIGNS LIST

100 . . . periphery monitoring apparatus for the work machine, 111 . . . first detection element, 112 . . . second detection element, 121 . . . first control element, 122 . . . second control element, 130 . . . output device, 131 . . . diagonally right front output device, 132 . . . front output device, 133 . . . diagonally left front output device, 134 . . . diagonally left rear output device, 135 . . . rear output device, 136 . . . diagonally right rear output device, 200 . . . work machine, 400 . . . operating device, 402 . . . seat (location of operator), A1 . . . right side detection target space, A2 . . . front detection target space, A3 . . . left side detection target space, A4 . . . rear detection target space, C1 . . . right side sensor, C2 . . . front sensor, C3 . . . left side sensor, C4 . . . rear sensor, S1 . . . diagonally right front target space, S2 . . . front target space, S3 . . . diagonally left front target space, S4 . . . diagonally left rear target space, S5 . . . rear target space, and S6 . . . diagonally right rear target space

1. A periphery monitoring apparatus for a work machine, comprising:
a first detection element configured to detect an operation state of an operating device for operating the work machine by an operator;
a second detection element configured to detect a position of an object existing around the work machine;
a plurality of output devices that are arranged in a plurality of azimuths with reference to a location of the operator in a driving space of the work machine so as to correspond to respective azimuths of a plurality of target spaces with reference to the work machine, and that output an alarm to the operator;
a first control element configured to determine a first designated target space that is at least a part of the plurality of target spaces, according to an action mode of the work machine which is predicted from the operation state detected by the first detection element; and
a second control element configured to cause a first designated output device among the plurality of output devices, which is arranged in the driving space of the work machine corresponding to an azimuth of the first designated target space with reference to the work machine, to output a different alarm according to a varying mode of a relative position of the object with respect to the work machine, which is determined by a time series of a position of the object detected by the second detection element, in a case where a position of the object detected by the second detection element is included in the first designated target space determined by the first control element.

2. The periphery monitoring apparatus for the work machine according to claim 1, wherein
the second control element causes the first designated output device to output an alarm in a different mode according to a difference in a varying mode of a distance between the work machine and the object, which is determined according to a relative position between the work machine and the object.

3. The periphery monitoring apparatus for the work machine according to claim 2, wherein
the second control element causes the first designated output device to output an enhancing alarm, when the distance between the work machine and the object becomes small, and causes the first designated output device to output a declining alarm, when the distance between the work machine and the object becomes large.

4. The periphery monitoring apparatus for the work machine according to claim 3, wherein
the second control element adjusts a varying rate of enhancement or declination of an alarm output by the first designated output device so as to become larger as the varying rate of the distance between the work machine and the object is larger.

5. The periphery monitoring apparatus for the work machine according to claim 1, wherein
when the position of the object detected by the second detection element heads from the first designated target space to a second designated target space which is another target space among the plurality of target spaces, the second control element causes an second designated output device that is arranged in the driving space so as to correspond to an azimuth of the second designated target space with reference to the work machine, in addition to the first designated output device, to output an alarm.

6. The periphery monitoring apparatus for the work machine according to claim 5, wherein
the second control element causes the second designated output device to output an alarm, after having caused the first designated output device to output an alarm.

7. The periphery monitoring apparatus for the work machine according to claim 6, wherein
the second control element varies a ratio of a period during which the second designated output device is caused to output an alarm, to a period during which the first designated output device is caused to output an alarm, according to a level of a moving speed of the object.

8. The periphery monitoring apparatus for the work machine according to claim 1, wherein
provided that the first detection element detects a transition from a non-interaction state between the operator of the operating device and the operating device to an interaction state, or a state in which the operator operates the operating device in a dead zone, as an operation state of the operator, the second control element controls the output device to a state capable of outputting an alarm.

9. The periphery monitoring apparatus for the work machine according to claim 1, wherein
the second control element causes the first designated output device to output an alarm in which each of a plurality of elements constituting an alarm sound as the alarm is differentiated in a different mode, according to each difference in varying modes of a relative position between the work machine and the object, and the distance between the work machine and the object.
